(19) United States
(12) Patent Application Publication
(10) Pub. No.: US 2022/0398993 A1
(43) Pub. Date: Dec. 15, 2022

(54) CONTROL APPARATUS, SIGNAL OUTPUT APPARATUS, SIGNAL DISTRIBUTING APPARATUS, DISPLAY APPARATUS, SYSTEM, CONTROL METHOD, AND STORAGE MEDIUM

(71) Applicant: CANON KABUSHIKI KAISHA, Tokyo (JP)

(72) Inventor: Shuichi Ohmori, Tochigi (JP)

(21) Appl. No.: 17/832,166

(22) Filed: Jun. 3, 2022

(30) Foreign Application Priority Data
Jun. 10, 2021 (JP) 2021-097072

(51) Int. Cl. G09G 5/00; G09G 3/00; H04N 9/31

(52) U.S. Cl. CPC G09G 5/006; G09G 3/001; H04N 9/3147; G09G 2300/026; G09G 2370/047

(57) ABSTRACT

A control apparatus includes an acquiring unit configured to acquire a plurality of identification data indicating display performances regarding image qualities of a plurality of display apparatuses, and a generating unit configured to generate a first identification datum indicating a display performance with which all the display apparatuses are compatible using the plurality of identification data.

### BACKGROUND OF THE INVENTION

### Field of the Invention

The present invention relates to a control apparatus, a signal output apparatus, a signal distributing apparatus, a display apparatus, a system, a control method, and a storage medium.

### Description of the Related Art

A multi-video display system that provides one large screen using a plurality of display apparatuses has conventionally been known in applications such as signage, live, event, and projection mapping. Japanese Patent No. (“JP”) 6773294 discloses a video apparatus in which in a case where one apparatus is a different model type from a subsequent apparatus, identification (ID) data of the one apparatus is rewritten to ID data of the subsequent apparatus in order to enable a repeater function. JP 4529553 discloses a control apparatus that recognizes an orientation, a display resolution, and brightness information of each display unit, divides an input image according to the resolution of each display unit, and uniformly adjusts the luminance of each display unit.

In a case where ID data indicating display performances regarding image qualities of a plurality of display units are different in the multi-video display system, there is a problem in that one or more display apparatus may not correctly display a video signal unless one ID data point (one ID datum) suitable for the multi-video display system is generated. However, each of JPs 6773294 and 4529553 is silent about a configuration that solves this problem.

### SUMMARY OF THE INVENTION

The present invention provides a control apparatus, a signal output apparatus, a signal distributing apparatus, a display apparatus, a system, a control method, and a storage medium, each of which can generate ID data suitable for a multi-video display system.

A control apparatus includes at least one processor, and at least one memory coupled to the at least one processor storing instructions that, when executed by the at least one processor, cause the at least one processor to function as an acquiring unit configured to acquire a plurality of identification data indicating display performances regarding image qualities of a plurality of display apparatuses, and a generating unit configured to generate a first identification datum indicating a display performance with which all the display apparatuses are compatible using the plurality of identification data. A signal output apparatus configured to output a video signal and including the above control apparatus also constitutes another aspect of the present invention. A signal distributing apparatus configured to divide a video signal from a signal output apparatus and to transmit a divided video signal to a plurality of display apparatuses and including the above control apparatus also constitutes another aspect of the present invention. A display apparatus configured as a primary unit and communicable with a plurality of display apparatuses as secondary units and including the above control apparatus also constitutes another aspect of the present invention.

A system according to another aspect of the present invention includes a signal output apparatus configured to output a video signal, and a plurality of display apparatuses configured to acquire the video signals. At least one of the signal output apparatus and the plurality of display apparatuses includes the above control apparatus. A system according to another aspect of the present invention includes a signal output apparatus configured to output a video signal, a signal distributing apparatus configured to divide the video signal, and a plurality of display apparatuses each configured to acquire a divided video signal. At least one of the signal output apparatus, the signal distributing apparatus, and the plurality of display apparatuses includes the above control apparatus. A control method corresponding to the above control apparatus also constitutes another aspect of the present invention.

Further features of the present invention will become apparent from the following description of exemplary embodiments with reference to the attached drawings.

### BRIEF DESCRIPTION OF THE DRAWINGS

FIG. 1 illustrates a multi-video display system according to a first embodiment.

FIG. 2 is a block diagram of the multi-video display system according to the first embodiment.

FIG. 3 is a flowchart illustrating setting processing by a signal distributing apparatus according to the first embodiment.

FIG. 4 illustrates a multi-video display system according to a second embodiment.

FIG. 5 is a block diagram of the multi-video display system according to the second embodiment.

FIG. 6 is a flowchart illustrating setting processing by a signal output apparatus of the second embodiment.

FIG. 7 illustrates a multi-video display system according to a third embodiment.

FIG. 8 is a block diagram of the multi-video display system according to the third embodiment.

FIG. 9 is a flowchart illustrating setting processing by a display apparatus of the third embodiment.

### DESCRIPTION OF THE EMBODIMENTS

Referring now to the accompanying drawings, a detailed description will be given of embodiments according to the present invention. Corresponding elements in respective figures will be designated by the same reference numerals, and a duplicate description thereof will be omitted.

### First Embodiment

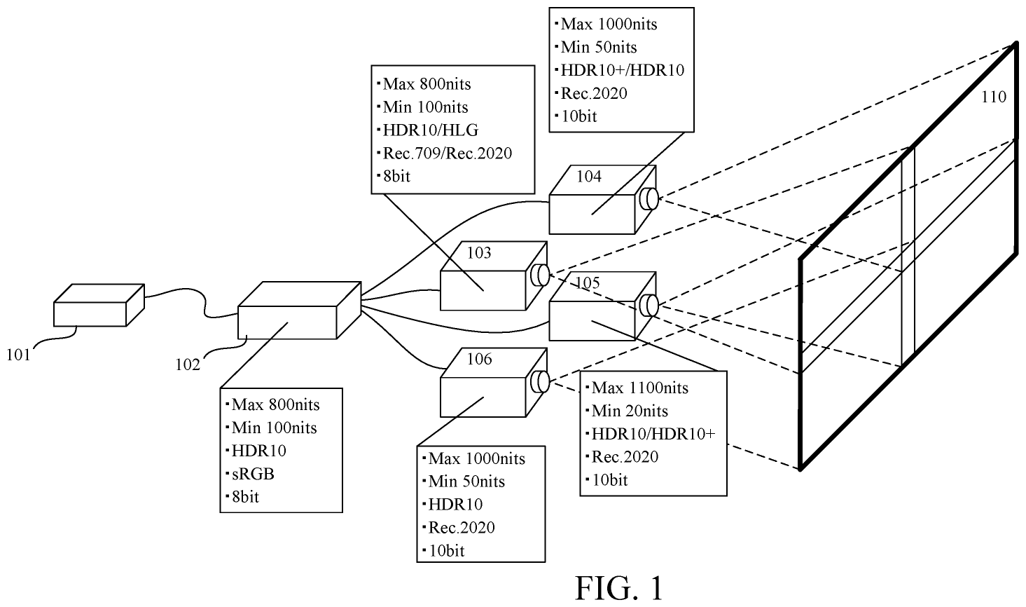

FIG. 1 illustrates a multi-video display system according to this embodiment. The multi-video display system according to this embodiment includes a signal output apparatus 101, a signal distributing apparatus 102, and display apparatuses 103 to 106.

The signal output apparatus 101 is a (Blu-ray (registered trademark) Disc: BD) playback device (reproducing apparatus) that can reproduce a BD that stores video content in this embodiment. The signal output apparatus 101 is not limited to the BD playback device as long as it can reproduce the video content compatible with High Dynamic Range (HDR) and output it as a video signal. The signal distributing apparatus 102 can receive the video signal from the signal output apparatus 101, divide video data for one screen (image) into four, and transmit the divided video data to the display apparatuses 103 to 106. The display apparatuses 103 to 106 are projectors in this embodiment, and the multi-video display system according to this embodiment can project a single image consisting of four images from the display apparatuses 103 to 106 on a screen 110. As illustrated in FIG. 1, the display apparatuses 103 to 106 have the same resolutions, but different luminance information (maximum (max)/minimum (min)), HDR formats, displayable color gamuts (color spaces), and bit depths of an RGB signal (color depths, numbers of bits). The display apparatuses 103 to 106 may be display units.

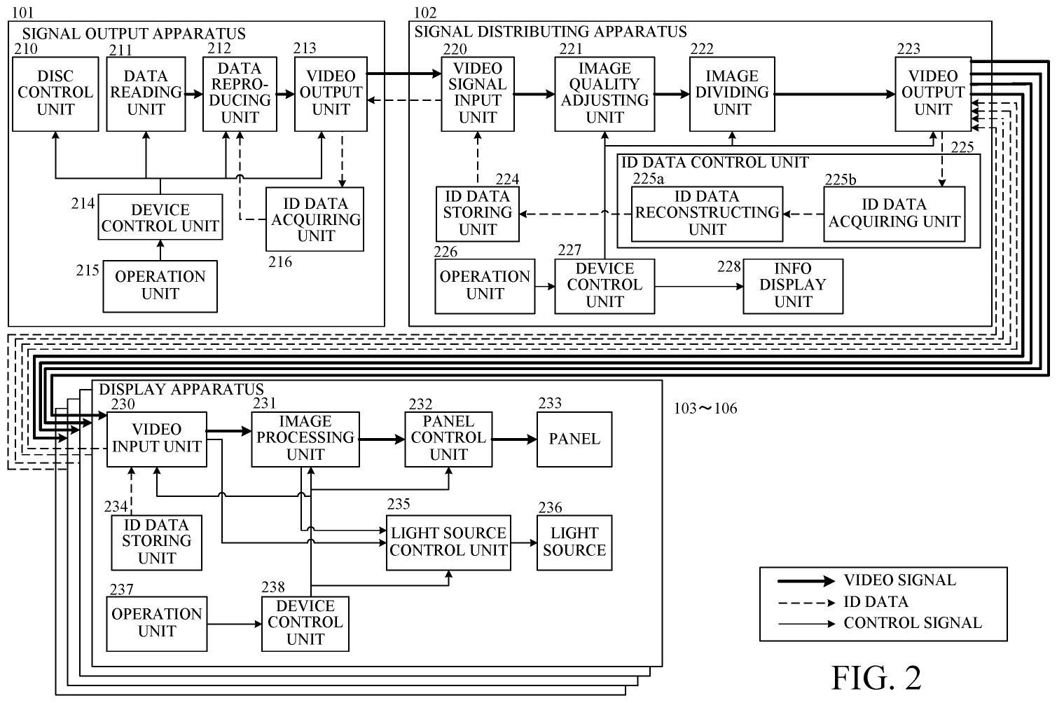

FIG. 2 is a block diagram of the multi-video display system according to this embodiment. The signal output apparatus 101 includes a disc control unit 210, a data reading unit 211, a data reproducing unit 212, a video output unit 213, a device control unit 214, an operation unit 215, and an identification (ID) data acquiring unit 216. The disc control unit 210 receives a signal from the device control unit 214 and provides disc-related physical control such as loading and unloading of a disc tray and rotating and stopping of the BD. The data reading unit 211 reads the video content data stored in the BD. The data reproducing unit 212 decodes the read video content data into the video signal such as RGB or YUV. In the decoding, the data reproducing unit 212 decodes the data into a proper (such as optimal) video signal according to first ID data suitable for the multi-video display system described below. The first ID data may be optimal ID data that makes best the display performance with which all the display apparatuses are compatible, that is, secures the broadest common display performance for all the display apparatuses. The video output unit 213 converts the video data from the data reproducing unit 212 into a format transmittable to display apparatuses 103 to 106 such as High Definition Media Interface (HDMI) and DisplayPort (DP), and then outputs the data. In addition, the video output unit 213 outputs the ID data suitable for the multi-video display system acquired from the signal distributing apparatus 102 to an ID data acquiring unit 216. The device control unit 214 instructs each unit to perform operations such as play, stop, fast forward, and reverse play according to an operation instruction input from the user through the operation unit 215.

The signal distributing apparatus 102 includes a video input unit 220, an image quality adjusting unit 221, an image dividing unit 222, a video output unit 223, an ID data storing unit 224, an ID data control unit 225, an operation unit 226, a device control unit 227, and an information display unit 228. The video input unit 220 receives the video signal from the external device and outputs ID data suitable for the multi-video display system stored in the ID data storing unit 224 to the signal output apparatus 101. The image quality adjusting unit 221 adjusts the image quality of the input video in accordance with an instruction from the device control unit 227. The image dividing unit 222 divides the input screen into a proper sub-screen size for each display apparatus from the number, and orientation and arrangement information of the display apparatuses acquired from the device control unit 227. The orientation and arrangement information is information indicating that the display apparatuses 103 to 106 are arranged two each (two by two) in vertical and horizontal directions as illustrated in FIG. 1 in this embodiment. The video output unit 223 is provided with a plurality of connection terminals, converts the divided video signal into a format transmittable to the display apparatuses 103 to 106, and then outputs the signal. In addition, the video output unit 223 communicates with each display apparatus and acquires information indicating a function and performance including ID data.

The ID data control unit 225 includes an ID data reconstructing unit (generating unit) 225a and an ID data acquiring unit 225b. The ID data acquiring unit 225b acquires a plurality of ID data indicating the display performance of each of the display apparatuses 103 to 106 from the video output unit 223. The ID data reconstructing unit 225a compares a plurality of ID data acquired from the ID data acquiring unit 225b, and generates an ID data point (ID datum; first (such as optimal) ID datum hereinafter) that is suitable for a multi-video display system (with which the display apparatuses 103 to 106 are compatible). In a case where the ID datum (that may include a plurality of items, each of which may include a plurality of pieces of information) is different for each display apparatus, the ID datum is generated by extracting a common factor in each ID datum in the greatest common factor manner, and by reproducing the extracted result as a unique datum. As long as the ID datum is uniquely determined, the number of items included in it is not limited to one. For example, the ID datum may include two or more items, such as HDR 10 and HLG. An ID datum indicating an HDR-compatible format usually describes all formats compatible with the display apparatus. When the display apparatus is compatible with both HDR 10 and HLG, the ID datum usually includes both of them and an apparatus that reproduces and/or outputs the content usually determines whether the video signal is to be output by HDR 10 or HLG. Similarly, in a case where the display apparatuses are compatible with both 4096×2160 and 1920×1080 as to the resolution, the ID datum includes information of these two resolutions. Thus, the ID datum is similar to EDID in the HDMI standard, which is a data set that describes the display performance of a display apparatus. EDID includes a plurality of items such as display luminance, resolution, and HDR format, and each item may include a plurality of pieces of information. The first ID datum generated by the ID data reconstructing unit 225a is stored in the ID data storing unit 224. The ID data storing unit 224 includes, for example, a memory represented by an EEPROM. The ID data control unit 225 is provided in the signal distributing apparatus 102 in this embodiment, but may be configured as a control apparatus separate from the signal distributing apparatus 102, or may be provided in the signal output apparatus or the display apparatus as described in an embodiment described below.

The device control unit 227 controls each component in the signal distributing apparatus 102 using the input signal from the operation unit 226 operated by the user. The information display unit 228 includes a small display, an LED, or the like, and notifies the user of the current setting information of the signal distributing apparatus 102 or the like.

The display apparatus 103 includes a video input unit 230, an image processing unit 231, a panel control unit 232, a panel 233, an ID data storing unit 234, a light source control unit 235, a light source 236, an operation unit 237, and a device control unit 238. The video input unit 230 receives the video signal from the external device and outputs the ID data to the signal distributing apparatus 102. The image processing unit 231 performs color adjustment and luminance adjustment based on an instruction from the device control unit 238. The panel control unit 232 converts the video signal from the image processing unit 231 into a signal format that can be input to a panel 233 and controls the panel 233 using the converted video signal. The panel 233 is a transmission-type liquid crystal panel in this embodiment, but may be a reflection-type liquid crystal panel or a Digital Mirror Device (DMD). The light source control unit 235 turns on and off the light source 236. The light source control unit 235 adjusts the brightness of the light source 236 using a luminance control value from the image processing unit 231 or an HDR signal separated from the video signal from the video input unit 230. The light source 236 is a high-intensity laser in this embodiment, but may be a high-intensity lamp. The device control unit 238 controls each component in the display apparatus 103 using an input signal from the operation unit 237 operated by the user.

In this embodiment, each of the display apparatuses 104 to 106 also has the same configuration as that of the display apparatus 103. However, as illustrated in FIG. 1, a plurality of ID data indicating display performances of the display apparatuses 103 to 106 are different, and the ID data of the respective display apparatuses are stored in the ID data storing unit 234.

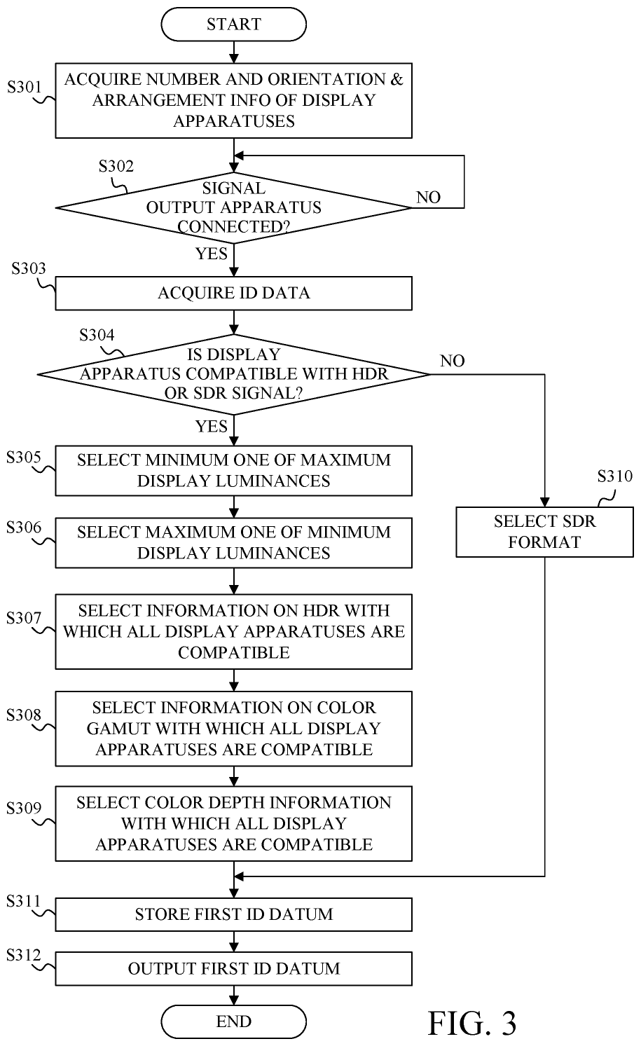

FIG. 3 is a flowchart illustrating setting processing by the signal distributing apparatus 102 according to this embodiment. The setting processing according to this embodiment is started when all apparatuses in the multi-video display system are powered on.

In step S301, the device control unit 227 acquires the number, and orientation and arrangement information of display apparatuses using the input signal from the operation unit 226 operated by the user.

In step S302, the signal distributing apparatus 102 determines whether or not the signal output apparatus 101 is connected. In the case where the connection is determined, the flow proceeds to step S303, and in the case where the disconnection is determined, this step is repeated.

In step S303, the ID data acquiring unit 225b acquires the ID data of the display apparatuses 103 to 106 via the video output unit 223.

In step S304, the ID data reconstructing unit 225a determines whether or not the display apparatuses 103 to 106 are compatible with an HDR or Standard Dynamic Range (SDR) signal, using the ID data acquired in step S303. In the case where it is determined that the display apparatuses 103 to 106 are compatible with the HDR signal, the flow proceeds to step S305. In the case where it is determined that at least one of the display apparatuses 103 to 106 is incompatible with the HDR and is compatible with the SDR signal, the flow proceeds to step S310.

In step S305, the ID data reconstructing unit 225a selects as the first ID datum the minimum one of the plurality of maximum display luminances of the ID data of the display apparatuses 103 to 106. Thus, in the case where the plurality of maximum display luminances are different, the minimum one of the plurality of maximum display luminances can be selected as the first ID datum.

In step S306, the ID data reconstructing unit 225a selects as the first ID datum the maximum one of the plurality of minimum display luminances of the ID data of the display apparatuses 103 to 106. Thus, in the case where the plurality of minimum display luminances are different, the maximum one of the plurality of minimum display luminances can be selected as the first ID datum.

In step S307, the ID data reconstructing unit 225a selects as the first ID datum information on HDR with which all the display apparatuses are compatible among multiple pieces of information on the HDR of the ID data of the display apparatuses 103 to 106. Here, the information on the HDR includes an HDR standard, an HDR method, an HDR set value, and the like. For example, when all the display apparatuses are compatible with HDR 10 and Hybrid LOG Gamma (HLG), they are selected as the first ID datum.

In step S308, the ID data reconstructing unit 225a selects as the first ID datum one piece of information on the color gamuts (color spaces) of the ID data of the display apparatuses 103 to 106 with which all the display apparatuses are compatible. For example, in the case where all the display apparatuses are compatible with Rec. 2020, Rec. 2020 is selected as the first ID datum.

In step S309, the ID data reconstructing unit 225a selects as the first ID datum color depth information with which all the display apparatuses are compatible among color depth (bit depth) information of the ID data of the display apparatuses 103 to 106.

In step S310, the signal distributing apparatus 102 selects the SDR format as the first ID datum (and does not select the HDR format).

In step S311, the ID data storing unit 224 stores the first ID datum including the data selected in steps S305 to S309 or step S310 in the internal memory.

In step S312, the video input unit 220 outputs the first ID datum stored by the ID data storing unit 224 to the video output unit 213 of the signal output apparatus 101.

As described above, the configuration of this embodiment can generate the first ID datum and provide a high-quality image.

### Second Embodiment

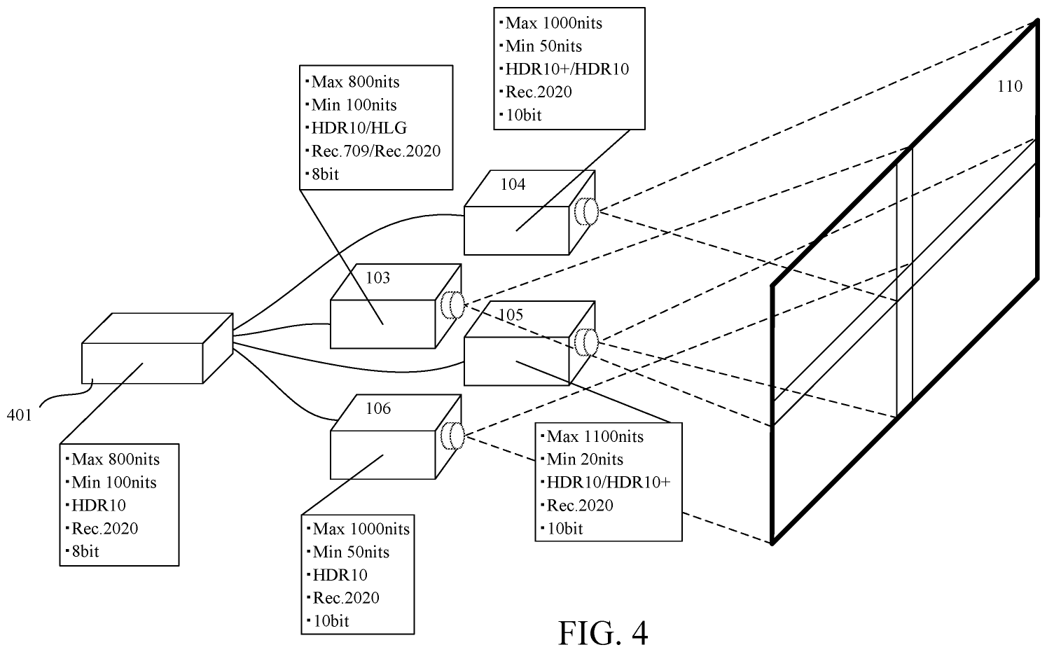

FIG. 4 illustrates a multi-video display system according to this embodiment. The multi-video display system according to this embodiment includes a signal output apparatus 401 and display apparatuses 103 to 106, and can project one image consisting of four images from the display apparatuses 103 to 106 onto the screen 110. This embodiment will discuss a configuration different from that of the first embodiment, and omit a description of a similar configuration.

The signal output apparatus 401 stores and reproduces video content, and divides video data for one screen (image) into a plurality of sub-screens (sub-images) and outputs a signal.

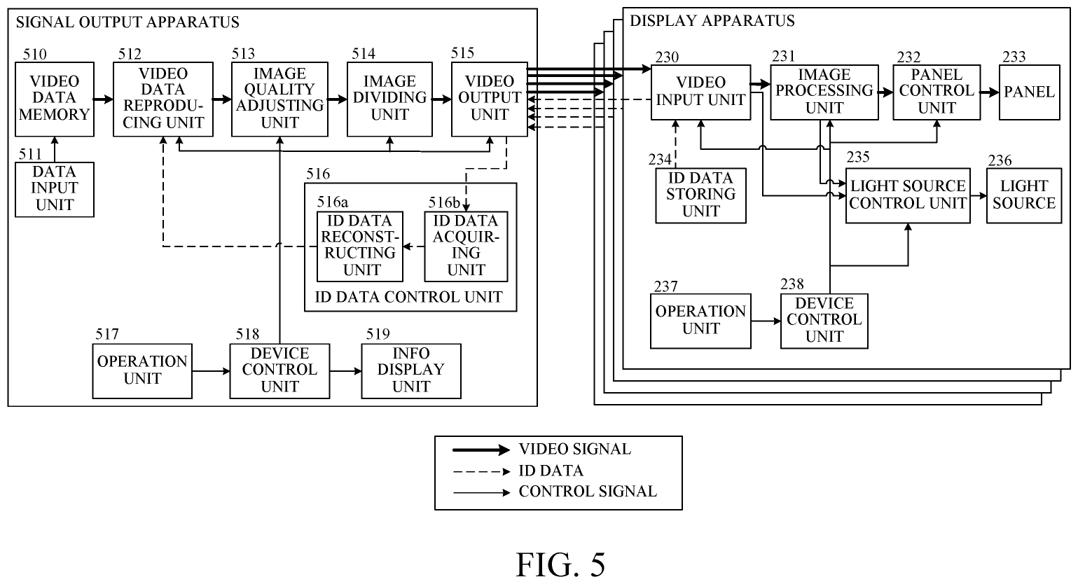

FIG. 5 is a block diagram of the multi-video display system according to this embodiment. The signal output apparatus 401 includes a video data memory 510, a data input unit 511, a video data reproducing unit 512, an image quality adjusting unit 513, an image dividing unit 514, a video output unit 515, an ID data control unit 516, an operation unit 517, a device control unit 518, and an information display unit 519. The video data memory 510 includes a hard disk drive or a storage device such as a Solid State Drive (SSD), and stores video content data. The data input unit 511 is an interface for writing the video content data into the video data memory 510. The video data reproducing unit 512 reads data out of the video data memory 510, decodes it into a video signal such as RGB or YUV, and adjusts it to the first HDR signal suitable for the display apparatuses 103 to 106 according to information from the ID data control unit 516. The image quality adjusting unit 513 adjusts the brightness, color, contrast, etc. of the entire screen in response to an instruction from the device control unit 518. The image dividing unit 514 divides the input screen into a proper sub-screen size for each display apparatus from the number, and the orientation and arrangement information of display apparatuses acquired from the device control unit 518. The orientation and arrangement information is information indicating that the display apparatuses 103 to 106 are arranged two each in vertical and horizontal directions as illustrated in FIG. 4 in this embodiment. The video output unit 515 converts the divided video signal into a format transmittable to the display apparatuses 103 to 106, and then outputs it. In addition the video output unit 515 communicates with each display apparatus and acquires information indicating a function and performance including ID data.

The ID data control unit 516 includes an ID data reconstructing unit (generating unit) 516a and an ID data acquiring unit 516b. The ID data acquiring unit 516b acquires a plurality of ID data indicating display performances of the display apparatuses 103 to 106 from the video output unit 515. The ID data reconstructing unit 516a compares the plurality of ID data acquired from the ID data acquiring unit 516b, and generates an ID data point (ID datum or first ID datum hereinafter) that is suitable for the multi-video display system (with which the display apparatuses 103 to 106 are compatible). The first ID datum is output to the video data reproducing unit 512, and used as information indicating display performance indicating the image quality of each display apparatus when decoded. The ID data control unit 516 is provided in the signal output apparatus 401 in this embodiment, but may be configured as a control apparatus separate from the signal output apparatus 401.

The device control unit 518 controls each component in the signal output apparatus 401 using the input signal from the operation unit 517 operated by the user. The information display unit 519 includes a small display, LEDs, or the like, and notifies the user of the current setting information of the signal output apparatus 401 and the like.

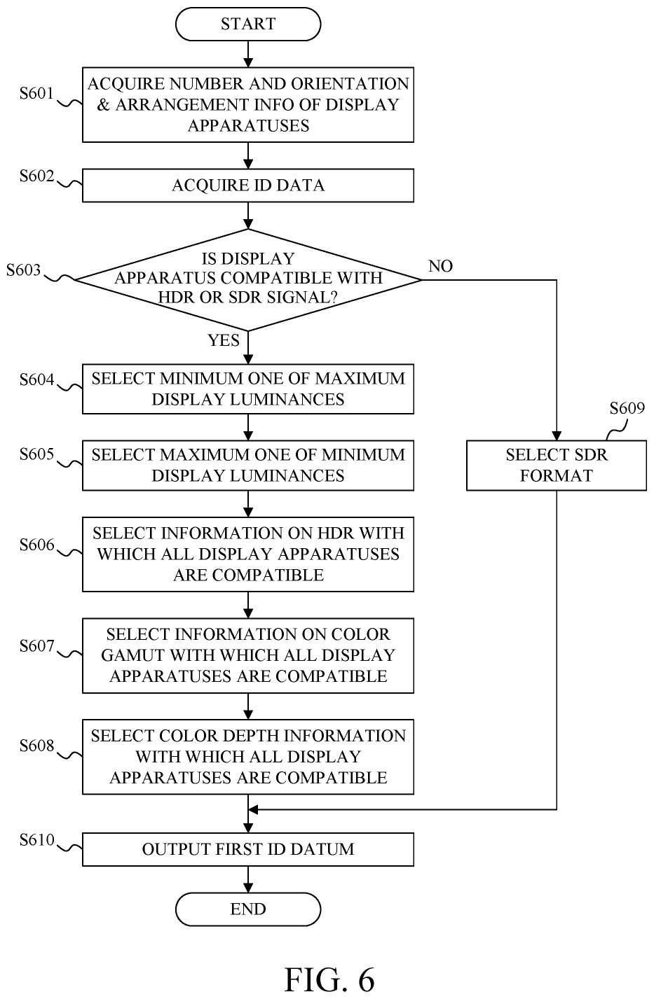

FIG. 6 is a flowchart illustrating setting processing by the signal output apparatus 401 according to this embodiment. The setting processing according to this embodiment is started when all the apparatuses in the multi-video display system are powered on.

In step S601, the device control unit 518 acquires the number, and orientation and arrangement information of the display apparatuses using the input signal from the operation unit 517 operated by the user.

In step S602, the ID data acquiring unit 516b acquires the ID data of the display apparatuses 103 to 106 via the video output unit 515.

Steps S603 to S609 are similar to steps S304 to S310 in FIG. 3, respectively, and the processing in the signal distributing apparatus 102 may be replaced with the processing in the signal output apparatus 401.

In step S610, the ID data reconstructing unit 516a outputs the first ID datum including the data selected in steps S604 to S608 or step S609 to the video data reproducing unit 512.

As described above, the configuration according to this embodiment can generate ID data with which the multi-video display system is compatible, and can provide high-quality images.

### Third Embodiment

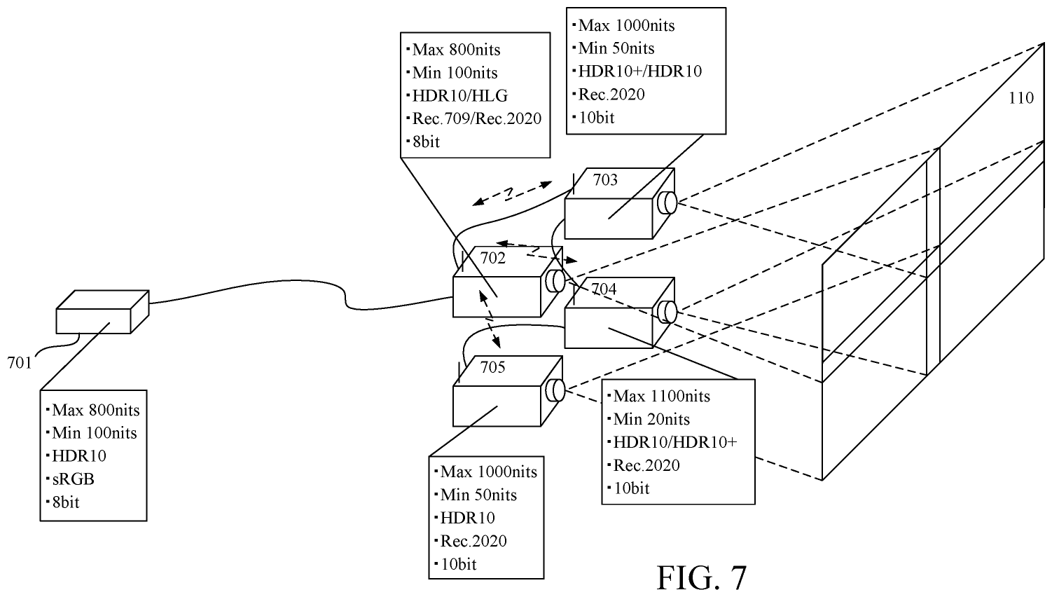

FIG. 7 illustrates a multi-video display system according to this embodiment. The multi-video display system according to this embodiment includes a signal output apparatus 701 and display apparatuses 702 to 705. This embodiment will discuss a configuration different from that of each of the first and second embodiments, and omit a description of a similar configuration.

The signal output apparatus 701 stores and reproduces video content, and outputs a video signal to the display apparatuses 702 to 705. A cable that transmits the video signal to each display apparatus is cascade-connected. The display apparatuses 702 to 705 are projectors in this embodiment, and are wirelessly connected to the network. The multi-display system according to this embodiment can project one image consisting of four images from the display apparatuses 702 to 706 onto the screen 110. As illustrated in FIG. 7, the display apparatuses 702 to 705 have the same resolution, but different luminance information (max/min), HDR formats, displayable color gamuts (color spaces) bit depths (color depths, number of bits) of the RGB signal. The display apparatuses 702 to 705 may be display units.

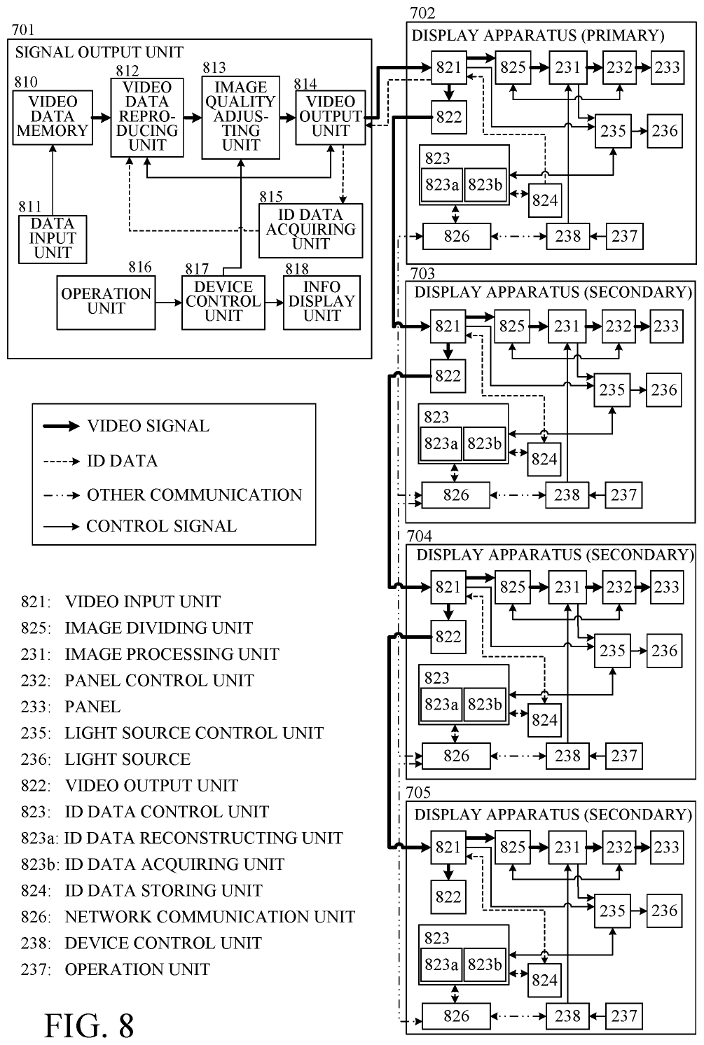

FIG. 8 is a block diagram of the multi-video display system according to this embodiment. The signal output apparatus 701 includes a video data memory 810, a data input unit 811, a video data reproducing unit 812, an image quality adjusting unit 813, a video output unit 814, an ID data acquiring unit 815, an operation unit 816, a device control unit 817, and an information display unit 818. The video data memory 810, data input unit 811, image quality adjusting unit 813, and video output unit 814 are similar to the video data memory 510, data input unit 511, image quality adjusting unit 513, and video output unit 515 in FIG. 5, respectively, and thus a detailed description thereof will be omitted. The ID data acquiring unit 815, the operation unit 816, the device control unit 817, and the information display unit 818 are similar to the ID data acquiring unit 516b, the operation unit 517, the device control unit 518, and the information display unit 519 in FIG. 5, respectively, and thus a detailed description thereof will be omitted. The video data reproducing unit 812 reads data out of the video data memory 810, decodes it into a video signal such as RGB or YUV, and adjusts the video signal according to the information from the ID data acquiring unit 815. In this embodiment, it is unnecessary to divide the video and transmit it to a plurality of display apparatuses, so that the signal output apparatus 701 may be provided with at least one connection terminal.

The display apparatus 702 includes a video input unit 821, a video output unit 822, an ID data control unit 823, an ID data storing unit 824, an image segmentation unit 825, and a network communication unit 826. The display apparatus 702 further includes an image processing unit 231, a panel control unit 232, a panel 233, a light source control unit 235, a light source 236, an operation unit 237, and a device control unit 238.

In this embodiment, each of the display apparatuses 703 to 705 also has the same configuration as that of the display apparatus 702. Moreover, in this embodiment, the display apparatus 702 connected to the signal output apparatus 701 is set to a primary unit, and the display apparatuses 703 to 705 are set to secondary units. The above settings may be manually set by the user for each display apparatus, or only the primary unit may be set by the user and the secondary units may be automatically set by the primary unit via network communication.

The video input unit 821 receives a video signal from an external device. In the display apparatus 702 as the primary unit, the video input unit 821 notifies the signal output apparatus 701 of the first ID datum suitable for the multi-video display system. The video input unit 821 notifies the light source control unit 235 of the HDR signal included in the video signal. The video output unit 822 outputs the video signal input from the video input unit 821 to the outside as it is. The network communication unit 826 can perform network communication with an external device, and uses a wireless LAN in this embodiment. Moreover, the network communication unit 826 has a host function and an access point function. In the display apparatus 702 as the primary unit, the network communication unit 826 functions as an access point of the wireless LAN, and establishes communication with the network communication units 826 in the display apparatuses 703 to 705 by the wireless LAN. In this embodiment, the network communication unit 826 uses the wireless LAN, but may use a method of connecting a wired LAN or serial communication in a cascade as long as it can be communicably connected to the external device.

The ID data control unit 823 includes an ID data reconstructing unit (generating unit) 825a and an ID data acquiring unit 823b. In the display apparatus 702 as the primary unit, the ID data acquiring unit 823b acquires a plurality of ID data indicating the display performances of the secondary display apparatuses 703 to 705 via the network communication unit 826. The ID data reconstructing unit 823a compares the ID data of its own apparatus stored in the ID data storing unit 824 with the plurality of ID data of other apparatuses acquired by the ID data acquiring unit 823b. The ID data reconstructing unit 823a gen generates an ID data point (ID datum or first ID datum) that is suitable for the multi-video display system (with which the display apparatuses 702 to 705 are compatible). The image segmentation unit 825 cuts out the video signal from the video input unit 821 into a sub-screen size to be divided and displayed by each display apparatus, and then provides appropriate scaling to the display resolution of the panel 233.

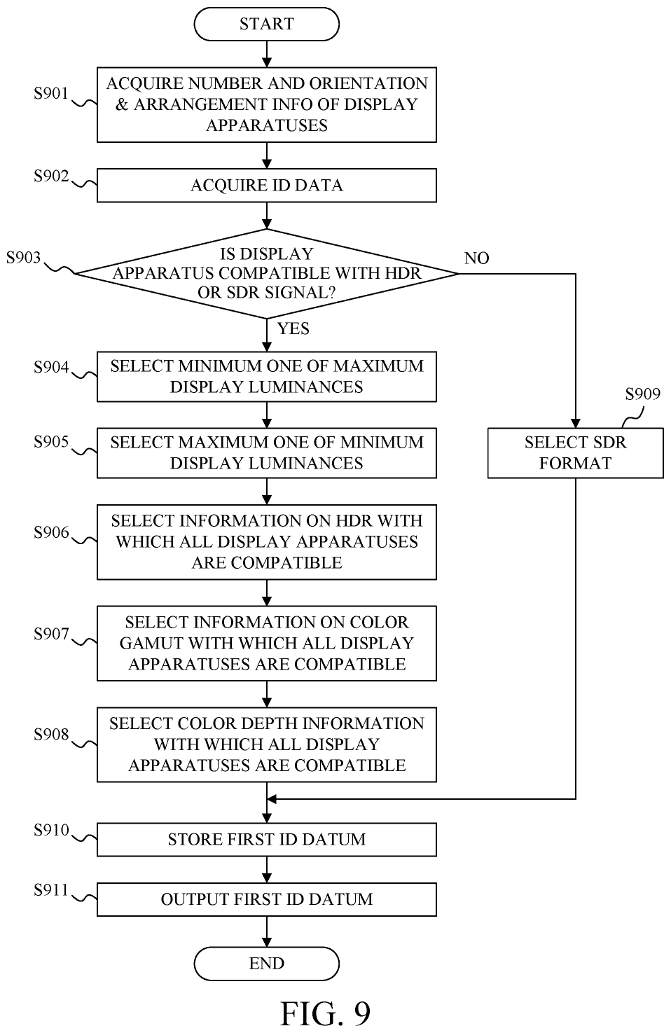

FIG. 9 is a flowchart illustrating setting processing to be executed by the display apparatus 702 as the primary unit according to this embodiment. The setting processing according to this embodiment is started when all the apparatuses in the multi-video display system are powered on and the primary and secondary units of the display apparatus are set.

In step S901, the device control unit 238 acquires the number, and orientation and arrangement information of the display apparatuses using the input signal from the operation unit 237 operated by the user. The orientation and arrangement information is information indicating that the display apparatuses 702 to 705 are arranged two each in vertical and horizontal directions as illustrated in FIG. 7 in this embodiment.

Steps S902 to S910 are similar to steps S303 to S311 in FIG. 3, respectively, and the processing in the signal distributing apparatus 102 may be replaced with the processing in the display apparatus 702.

In step S911, the video input unit 821 outputs the first ID datum stored by the ID data storing unit 824 to the video output unit 814 of the signal output apparatus 701.

In this embodiment, the display apparatus 702 connected to the signal output apparatus 701 is set to the primary unit, but the present invention is not limited to this example. In step S911, if the first ID datum is written from the display apparatus set as the primary unit into the ID data storing units 824 of all the display apparatuses via the network, the display apparatus other than the display apparatus 702 may be set as the primary unit.

As described above, the configuration according to this embodiment can generate ID data with which the multi-video display system is compatible, and provide high-quality images.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-097072, filed on Jun. 10, 2021, which is hereby incorporated by reference herein in its entirety.

What is claimed is:

1. A control apparatus comprising:
at least one processor; and
at least one memory coupled to the at least one processor storing instructions that, when executed by the at least one processor, cause the at least one processor to function as:
an acquiring unit configured to acquire a plurality of identification data indicating display performances regarding image qualities of a plurality of display apparatuses; and
a generating unit configured to generate a first identification datum indicating a display performance with which all the display apparatuses are compatible using the plurality of identification data.

2. The control apparatus according to claim 1, wherein the plurality of identification data include information indicating whether or not an HDR signal is compatible, or information indicating whether or not an SDR signal is compatible, and
wherein in a case where at least one of the plurality of display apparatuses is not compatible with the HDR signal and is compatible with the SDR signal, the generating unit selects the information indicating the SDR signal is compatible as the first identification datum.

3. The control apparatus according to claim 1, wherein the plurality of identification data include a maximum display luminance of a compatible display apparatus, and
wherein in a case where at least one display apparatus has a maximum display luminance different from that of another display apparatus in the plurality of display apparatuses, the generating unit selects a minimum one of the maximum display luminances as the first identification datum.

4. The control apparatus according to claim 1, wherein the plurality of identification data include a minimum display luminance of a compatible display apparatus, and
wherein in a case where at least one display apparatus has a minimum display luminance different from that of another display apparatus in the plurality of display apparatuses, the generating unit selects a maximum one of the minimum display luminances as the first identification datum.

5. The control apparatus according to claim 1, wherein the plurality of identification data include information on HDR with which a compatible display apparatus is compatible, and
wherein in a case where at least one display apparatus has information on compatible HDR different from that of another display apparatus in the plurality of display apparatuses, the generating unit selects information on HDR with which all the display apparatuses are compatible, as the first identification datum.

6. The control apparatus according to claim 1, wherein the plurality of identification data include information on a color gamut with which a compatible display apparatus is compatible, and
wherein in a case where at least one display apparatus has information on a compatible color gamut different from that of another display apparatus in the plurality of display apparatuses, the generating unit generates information on a color gamut with which all the display apparatuses are compatible, as the first identification datum.

7. The control apparatus according to claim 1, wherein the plurality of identification data include a color depth with which a compatible display apparatus is compatible, and
wherein in a case where at least one display apparatus has a compatible color depth different from that of another display apparatus in the plurality of display apparatuses, the generating unit selects a color depth with which all the display apparatuses are compatible, as the first identification datum.

8. The control apparatus according to claim 1, wherein the first identification datum is an identification datum that secures the broadest common display performance for all the display apparatuses.

9. A signal output apparatus configured to output a video signal, the signal output apparatus comprising a control apparatus,
wherein the control apparatus includes:
at least one processor; and
at least one memory coupled to the at least one processor storing instructions that, when executed by the at least one processor, cause the at least one processor to function as:
an acquiring unit configured to acquire a plurality of identification data indicating display performances regarding image qualities of a plurality of display apparatuses; and
a generating unit configured to generate a first identification datum indicating a display performance with which all the display apparatuses are compatible using the plurality of identification data.

10. A signal distributing apparatus configured to divide a video signal from a signal output apparatus and to transmit a divided video signal to a plurality of display apparatuses, the signal distributing apparatus comprising the control apparatus according to claim 1.

11. A display apparatus configured as a primary unit and communicable with a plurality of display apparatuses as secondary units, the display apparatus comprising the control apparatus according to claim 1.

12. A system comprising:
a signal output apparatus configured to output a video signal; and
a plurality of display apparatuses configured to acquire the video signals,
wherein at least one of the signal output apparatus and the plurality of display apparatuses includes the control apparatus according to claim 1.

13. The system according to claim 12, wherein the signal output apparatus includes a reproducing unit configured to adjust the video signal based on the first identification datum.

14. A system comprising:
a signal output apparatus configured to output a video signal;
a signal distributing apparatus configured to divide the video signal; and
a plurality of display apparatuses each configured to acquire a divided video signal,
wherein at least one of the signal output apparatus, the signal distributing apparatus, and the plurality of display apparatuses includes the control apparatus according to claim 1.

15. The system according to claim 14, wherein the signal output apparatus includes a reproducing unit configured to adjust the video signal based on the first identification datum.

16. A control method comprising the steps of:
acquiring a plurality of identification data indicating display performances regarding image qualities of a plurality of display apparatuses; and
generating a first identification datum indicating a display performance with which all the display apparatuses are compatible using the plurality of identification data.

17. A non-transitory computer-readable storage medium storing a program that causes a computer to execute the control method according to claim 16.
